(19) United States
(12) Patent Application Publication
(10) Pub. No.: US 2015/0235004 A1
(43) Pub. Date: Aug. 20, 2015

(54) PLATFORM, DEVICE AND METHOD FOR SOCIAL MEDICATION MANAGEMENT

(71) Applicant: MediSafe Project LTD, Nofit (IL)

(72) Inventors: Omri Shor, Nofit (IL); Rotem Shor, Nofit (IL)

(21) Appl. No.: 14/624,133

(22) Filed: Feb. 17, 2015

Related U.S. Application Data
(60) Provisional application No. 61/940,717, filed on Feb. 17, 2014.

(51) Int. Cl. G06F 19/00; G06Q 50/00; G06Q 50/22

(52) U.S. Cl. CPC G06F 19/3456; G06Q 50/22; G06Q 50/01

(57) ABSTRACT

A system, method and platform are herein provided for enabling social medication adherence enhancement. According to one embodiment a system or platform is provided for socially supporting medication adherence management, comprising a user application for managing medication adherence, data servers with memory thereon for storing adherence related data, and web servers running code to enable social medication adherence tracking.

This application claims the benefit of U.S. Provisional Application No. 61/940,717 filed Feb. 17, 2014, which is hereby incorporated by reference in its entirety.

### BACKGROUND OF THE INVENTION

Medication or drug adherence (sometimes also referred to as compliance, capacitance or Concordance) describes the degree to which a patient correctly follows medical instructions. Both the patient and the health-care provider affect adherence, and a positive physician-patient relationship is an important factor in improving adherence.

Worldwide, non-adherence is a major obstacle to the effective delivery of health care. Estimates from the World Health Organization (2003) indicate that only about 50% of patients with chronic diseases living in developed countries follow treatment recommendations. Adherence rates may be overestimated in the medical literature, as adherence is often high in the setting of a formal clinical trial but drops off in a “real-world” setting.

Major barriers to adherence are thought to include the complexity of modern medication regimens, poor “health literacy” and lack of comprehension of treatment benefits, the occurrence of undiscussed side effects, the cost of prescription medicine, and poor communication or lack of trust between the patient and his or her health-care provider. Efforts to improve adherence have been aimed at simplifying medication packaging, providing effective medication reminders, improving patient education, and limiting the number of medications prescribed simultaneously.

It would be highly advantageous to have a system, platform or method that could enable medication takers to be helped to take medications on time, and to be better monitored and supported.

### SUMMARY OF THE INVENTION

There is provided, in accordance with an embodiment of the present invention, a platform, system and method for social medication adherence.

According to one embodiment a system or platform is provided for socially supporting medication adherence management, comprising: a user application for managing medication adherence, data servers with memory thereon for storing adherence related data, and web servers running code to enable social medication adherence tracking

In further embodiments, the medication adherence system may further include computer code for enabling the personalization of system communications based on personal user criteria and/or user behavior tracking analytics.

In additional embodiments, the medication adherence system may further include user behavior tracking, optionally integrating medication administering gesture tracking based on a user movement, through one or more movement sensors, for example, in or connected to wearable devices or connected devices.

In still further embodiments, the medication adherence system may further include predictive algorithms to enable enhanced alerting of users based on predictions of likely non-adherence.

According to some embodiments, a platform for social medication management is herein provided, which may include: a social media enabled website and medicine adherence services with complete social media network functionality; a mobile computing device enabled with a medication management application including a virtual pill box; a medication adherence database; and a group management portal for enabling user medication management data with a selected social group. In still further embodiments the platform integrates connectivity to third party modules.

In some embodiments the platform may further comprise a data security module.

In some embodiments the platform may further comprise a group alert module for alerting a selected social group of an event.

According to some embodiments, a method is provided for enabling social medication adherence management, comprising: downloading an application to a mobile communications device, where the application is enabled to display a virtual pill box; connecting to a medication adherence management platform; setting up a social group connected to a user via the platform, to help monitor user medication adherence; inserting medication data into the platform, via the application; inserting medication adherence data into the platform, via the application; and tracking medication adherence of a user, by the social group.

In some embodiments, the method may further comprise synchronizing user medication data and user medication adherence data between the social group.

In some embodiments, the method may further comprise utilizing one or more sensors. For example, in wearables and/or other connected devices, to add user medication adherence data to the platform.

In still further embodiments, the method may further comprise tracking user movement to identify medication adherence data, and automatically entering such data into the platform.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting critical elements of a social medication management system, according to some embodiments;

FIG. 2 is a schematic system diagram depicting components of the social medication adherence platform, for enabling user download and usage, according to some embodiments;

FIG. 3 is a flow diagram indicating an example of a process by which a social medication adherence application operates, in cooperation with the medication adherence system, according to some embodiments; and

FIG. 4 is a flow diagram indicating the process by which a medication intake is socially managed, in cooperation with the social medication adherence system, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

As used herein, the term “social” may include a group, club, or community of one or more people. The term “social group” may include individuals or organizations, including friends, family, support groups, support staff, medical practitioners, medical centers, laboratories, pharmacies etc.

According to some embodiments of the present invention, a platform is provided for providing social medication adherence management. In some embodiments automated registration of medications is enabled.

In some embodiments, medication adherence management and control includes a social support feature, whereby a group, such as a family, may be communicatively connected to a medication taker, to receive alerts, updates, enable multi-way communications etc. to further enhance medication adherence and reduce mistakes in medication adherence.

Non-limiting embodiments of the present invention include a system, method and/or means for facilitating social medication adherence. In some embodiments, systems and methods are provided for enabling group based adherence.

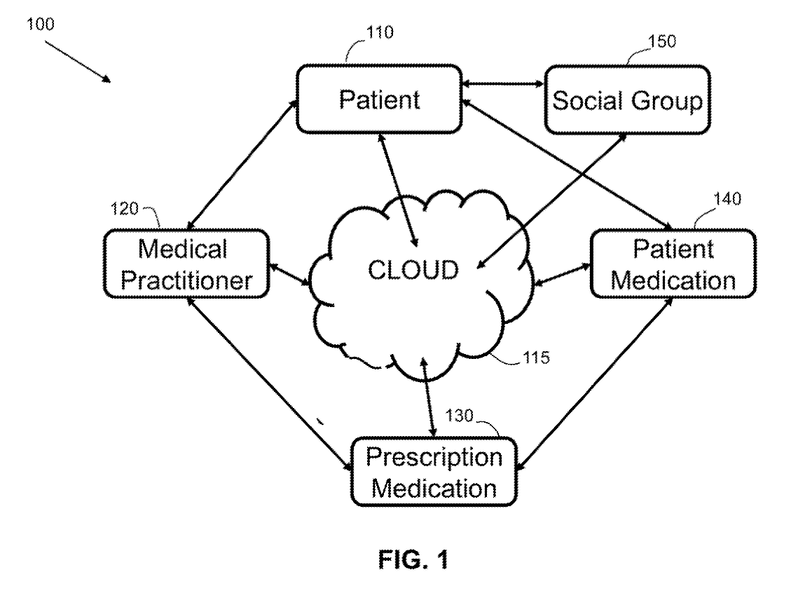

FIG. 1 is a schematic system diagram depicting critical elements of a social medication management system 100, according to some embodiments. As can be seen in FIG. 1, typical social medication management system includes a patient 110, medical practitioner or organization 120, the prescription medication 130, instructed by the practitioner 120, and the actual patient medication 140, which patient 110 is supposed to take in the correct way. In some embodiments, the medication adherence loop may further include a social group or family 150, to support the patient 110, which is a significant addition to the typical patient medication environment. The family or other selected group 150 may be included in communications, alerts, updates etc. that related to a patient in the social medication management system 100. The social group may include an individuals or organizations connected to the user, for example, medical practitioners, data centers, medical centers, pharmacists, support groups, family, friends etc.

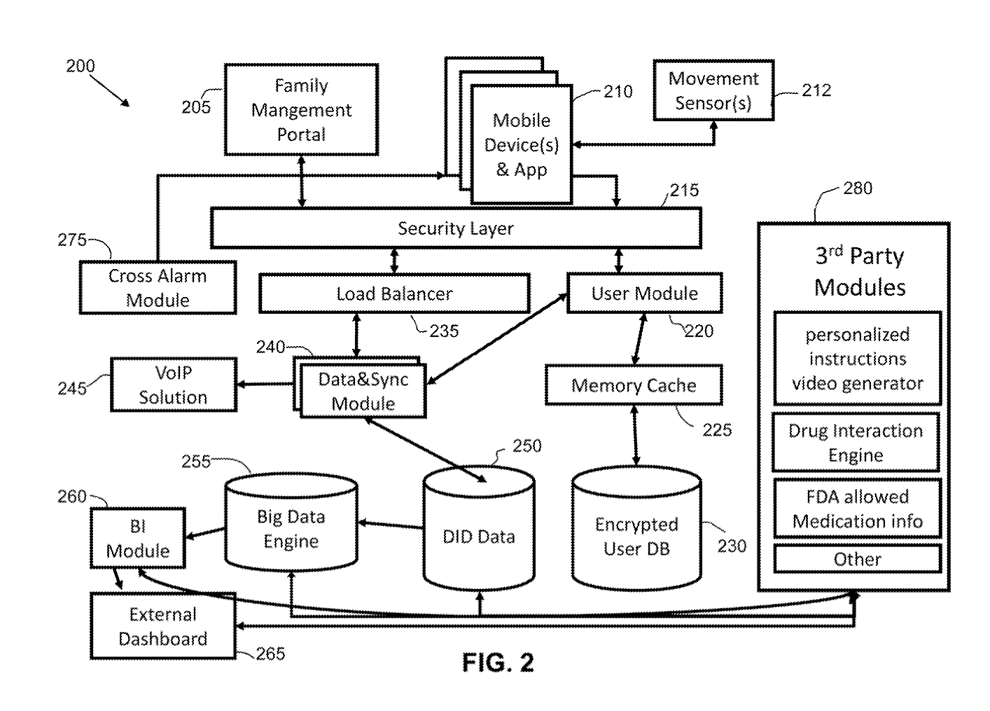

FIG. 2 is a schematic system diagram depicting components of a social medication management platform 200, according to some embodiments. As can be seen in FIG. 2, a group user interface is provided, such as a family management portal 205, and a mobile or smart device with a medication management Application (App) 210, optionally connected to or integrating one or more movement sensors (e.g., from wearable devices and/or other connected devices) 212, served by a web server (not shown in the figure) is provided for access to the portal 205 from substantially any connected device. User access is generally channeled through a security layer 215 to ensure user authentication, permissions, and access to data. In general a user makes use of a User Module 220 to access user data, optionally from memory cache 225, and generally as stored on encrypted user Database 230. User Module 220 may be connected to a Data and Sync Module 240, to keep data updated and synchronized for users, optionally using a VoIP solution 245, or other secure data interface. Data and Sync Module 240 may also be in connection with a load balancer 235, to help stabilize and secure data transfers. In some embodiments, a cross Alarm module 275 may also be provided, for example, for connecting system users to other system users, which may hereinafter defined as a medication adherence friend or connection, to enable mutual notifications and alerts etc. Data and Sync Module 240 may also be communicatively connected to a De-Identified data (DID) storage, which is in communication with a Big Data Engine 255, for example a cross-platform document-oriented database system such as Mongo DB. Big Data Engine 255 may be in communication with a Business Intelligence module 260. In some examples an external control dashboard 265 may be provided, for example a Pharma companies dashboard, or other selected dashboard for a specialized or generic segment or space. In general, one or more system components described above may include a file(s) with running a program or set of instructions to execute commands to enable execution of medication adherence related enhancements. In some embodiments, 3^{rd} Party modules may be communicatively connected to and/or integrated into one or more system modules. For example, video generators for personal instructions, drug interaction engines, and FDA allowed medication information systems etc. may be in communication with DID data module 250, Big Data Engine 255, BI Module 260 and Control Dashboard 265 etc. In some embodiments a Queue server may be integrated into the system, to enable smart queuing of data processing and communications. In other embodiments a transaction server may be integrated into the system, to facilitate user transactions, and optionally payment based transactions.

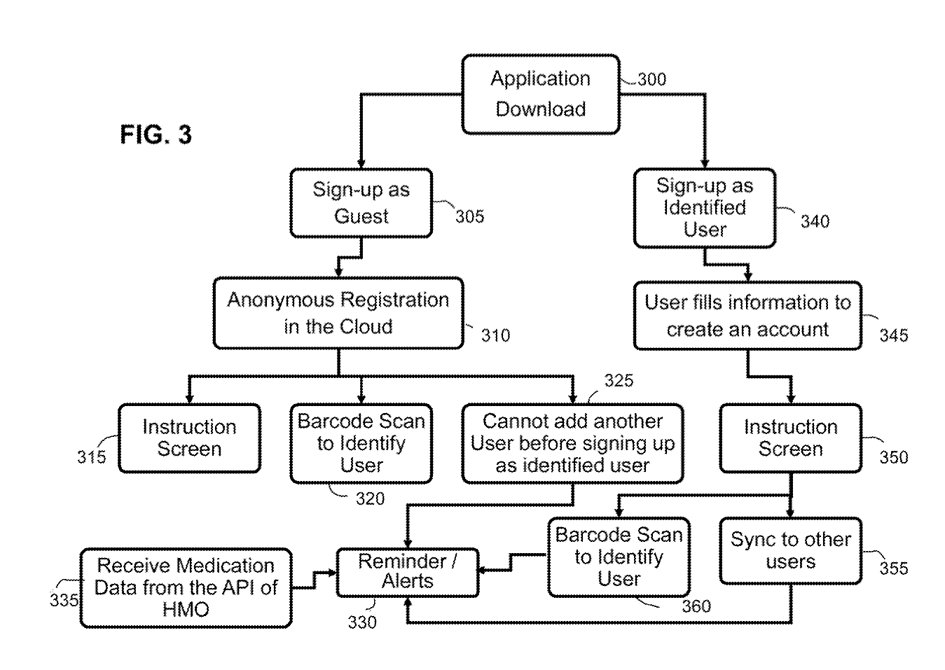

FIG. 3 is a flow diagram indicating an example of a process by which a medication adherence application operates, in cooperation with the medication adherence system, according to some embodiments. As can be seen in FIG. 3, at step 300 a user may download an application or interface code. At step 305 the user may sign up, optionally as a guest, in which case they may at step 310 anonymously register on the cloud/Website. Typically the user may be provided at step 315 with an instruction screen, and/or with a scanning or identification option, for example, a bar code scan, at step 320. Generally a user will need to register before being allowed to add another user, at step 325.

At step 340 a user can sign up as a member or identified user. At step 345 the user may fill in user information to open an account. At step 350 the user may make use of an instruction screen(s) and optionally use a scanning or identification option, for example, a bar code scan, at step 360. At step 355 an identified user may be able to sync or connect with other users. In any case, whether the user is identified or anonymous, the user may initiate and/or be in receipt of alerts, updates and/or reminders, at step 330. Additionally, at step 335, the users may be in receipt of reminders, updates or alerts initiated by medical practitioners or organizations, for example, such as medication data alerts generated by an API of an HMO, hospital, practitioner, pharmacy etc. Of course, other steps or combination of steps may be used.

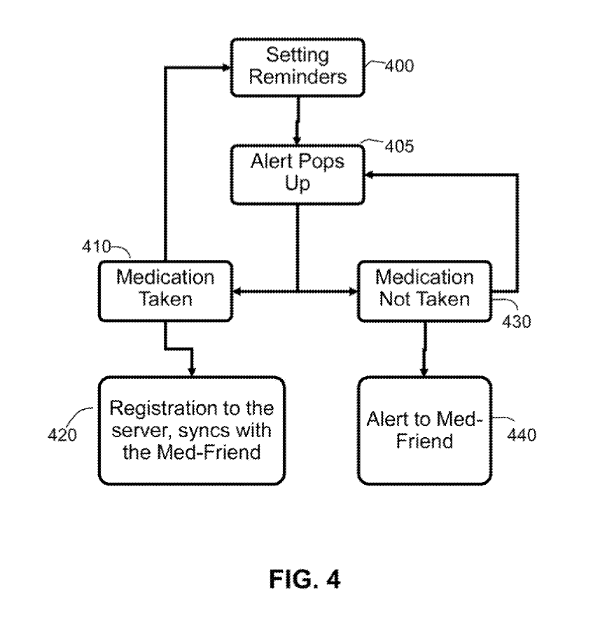

FIG. 4 is a flow diagram indicating the process by which a medication adherence is managed, in cooperation with the social medication adherence system, according to some embodiments. As can be seen in FIG. 4, at step 400 reminders may be set, manually or automatically, whether by the medication instructor, distributer, patient and/or patient support group, or others in the medication adherence environment. At step 405 an alert, update, message etc. may be sent to the patient or other users of the system. Such alerts may be in the form of emails, instant messages, chats, or other relevant formats or types. In general the patient or patient support team may be requested by the alert to respond with an update. For example, at step 410, if the medication has been taken, a user may enter this fact, optionally in response to the alert, or independently of the alert. Such a data entry may then neutralize or otherwise change the status of the current alert, and may be used to manually or automatically reset the reminders settings, at step 400. In the case where, at step 430, medication has not been taken, example, a user may enter this fact, optionally in response to the alert, or independently of the alert. In such a case, the alert may be recycled or re-activated, at step 440. For example, the alert may be sent immediately or later (e.g. time defined by patient or automatically set by the app) to the patient, to the patients support group, the patients practitioner etc. Of course, other steps or combination of steps may be used.

In accordance with some embodiments, mobile applications or “Apps” may be developed for various platforms or operating systems. Apps may optionally use the scanning capabilities of remote mobile or computing devices. The medication adherence system described herein may include mobile application interfaces, desktop interfaces and point of contact (POC) terminals, may enable adherence management from receipt of instructions from a practitioner, through the purchase or acquisition of medication, and during execution or usage of the medications. The system will enable continual or periodical monitoring of medication adherence, and sending of messages such as alerts and updates, to help encourage enhanced medication taking, and preventing forgetfulness or other factors active in decreasing adherence. The application or interface may include usage of graphics, video, voice, scanning, positioning data, user movement data and more to aid medication adherence monitoring. Applications in some cases may be customized for selected populations, conditions, environments etc. In some embodiments, an application for mobile computing or computing devices may include a virtual pill box representing the pills to be taken by a user during one or more time periods. In some examples the virtual pill box may enable the end user or the end user's social group to graphically view the pills to be taken over or in a period of time, as well as the pills that have been taken over or during a time period. In one example, the virtual pill box may have a graphic interface that may be divided into multiple segments or compartments, reflecting the medications that a user should take and/or has taken in multiple periods of the day. Optionally the time of the pill to be taken or that has been taken may be displayed. Optionally the time of the pill to be taken or that has been taken may be displayed in different fonts, colors, or with other effects to help alert the user or inform the user of medication taking adherence.

In some embodiments, a platform for social medication safety management is provided, which may include a social media enabled website and medicine adherence services with complete social media network functionality; a mobile computing device enabled with a medication management application including a virtual pill box; a group management portal; a medication adherence database; and connectivity to third party modules.

In further embodiments the platform may further include a data security module.

In still further embodiments the platform may include a group alert module for alerting a selected social group of an event.

In general, the system may be cloud based and scalable to be used with any number of users. Further, in some embodiments, a distributed computing platform may be used, to help enable the analysis and processing of large amounts of information accumulated substantially in real time, by using significant computing power to process data as necessary.

The system may use external data from, for example, HMO's, medical organizations, government data sources, online sources, personal medical records, personal location data etc. Further, the system may make use of data from social networks, and may facilitate formation of user profiles and/or groups or group profiles, for example, to allow building of a social network related to a medication, condition etc. For example, “objective” user data such as age, gender, race, etc. may be used to contribute to user profile setup, along with actual user behavior, user preferences etc.

In further embodiments, the system may analyze, optionally processing with artificial intelligence algorithms or other processing means, to create customized alerts, features, suggestions, predictions etc., to enhance the user experience. For example, the system may enable analyzing personal usage patterns, interests, needs, limitations etc., to provide interfaces, services, suggestions etc. to maximize user medication adherence and minimize the likelihood that a user will fail to take the medication.

In further embodiments, the medication adherence system may further include computer code for enabling the personalization of system communications based on personal criteria and/or behavior tracking

In additional embodiments, the medication adherence system may further include user behaviour tracking, optionally integrating medication administering gesture tracking based on a user movement sensor device (such as a wearable device and/or other connected device(s)). In still further embodiments, a method for enabling social medication adherence management may further comprise tracking user movement to identify medication adherence data, and automatically entering such data into the platform. For example, one or more sensors worn by a user, carried by a user or integrated into a user's computing or communications device may be used to track and process user movements, such as determining when a user moves their hand(s) to open a pill, take a pill, drink water, swallow a pill etc.

In still further embodiments, the medication adherence system may further include predictive algorithms to enable enhanced alerting of users based on predictions of likely non-adherence.

In still a further embodiment, businesses or organizations may use user adherence tracking to enable matching or processing of such data in combination with data from drug companies, distributors, manufacturers, hospitals, HMO's etc. Such data processing may aid statistical evaluations of past, current and/or future medication usage, as well as predictions for usage, health threats, etc. immediate alerts medication use.

In some embodiments data from the system may be used to deliver reports and/or process data to enable drug companies, distributors, manufacturers, hospitals, HMO's etc. to provide usage reports and predictions. Such data may help aid resource planning, production planning, health alert prediction etc.

In accordance with some embodiments, the system may integrate usage of wearable or other body tracking devices to help enable enhanced adherence. Accordingly, the system may be configured to correlate with a user's wearable device to help determine medication taking history and/or prediction of taking. For example, a user may make use of a wearable management sensor, optionally integrated into their hand watch or other devices, to use the device sensors to determine adherence data such as time of consumption. In some examples, the wearable device sensor may function as a gesture monitor, for example to determine if and when a user has made a medication opening/preparation movement, intake movement etc. In still further embodiments specialized gestures related to medication adherence may be defined, monitored and tracked, to help determine user adherence optionally without relying on user data entry.

In accordance with additional embodiments, predictive analysis may be used to predict user medication adherence, and provide functionality enhancements in accordance. In some examples, user entered preferences and/or behavior tracking analytics on various levels or various sensitivities or resolutions may be used to predict likely medication taking or failure to take medicines. In one example, adherence prediction may be based on analysis of user location, time, activity, and company used to predict likelihood of taking medication. As a result, if a certain situation is assumed to create a likelihood of forgetfulness to take medication, then a higher level of alert may be initiated to encourage the user to take medication. Of course other factors or combination of factors may be used. In a further example, based on system data analysis, it has been established that users in a certain geographical area are less likely to take medications in the evenings on weekends, in which case further measures such as group alerts may be used at these times to encourage extra vigilance in medication taking at these times for users in these places. Of course, alerts or other smart events may be triggered by the system to compensate for increased likelihood of non-adherence.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for medication adherence management, comprising:
a user application for managing medication adherence;
a data server with memory thereon for storing adherence related data; and
a web server running code to enable social medication adherence tracking, by sharing user application data with a selected social group.

2. The system of claim 1, further including computer code for enabling the personalization of system communications based on user behavior tracking analytics.

3. The system of claim 2, wherein said user behavior tracking includes medication administering gesture tracking based on one or more movement sensors.

4. The system of claim 2, wherein said personal user behavior tracking includes medication adherence tracking based on one or more sensors selected from the group consisting of wearables sensors, connected devices, mobile device sensors, and other body tracking devices worn by or used by an end user.

5. The system of claim 1, further including predictive algorithms to enable alerting of system users based on predictions of likely non-adherence.

6. A platform for social medication management, comprising:
a social media enabled website and medicine adherence services with complete social media network functionality;
a mobile computing device enabled with an medication management application including a virtual pill box;
a medication adherence database; and
a group management portal for enabling user medication management data with a selected social group.

7. The platform of claim 6, further comprising connectivity to third party modules.

8. The platform of claim 6, further comprising a data security module.

9. The platform of claim 6, further comprising a group alert module for alerting a selected social group of an event.

10. The platform of claim 6, further comprising a gesture tracking module and one or more movement sensors.

11. A method for enabling social medication adherence management, comprising:
downloading an application to a mobile communications device, where the application is enabled to display a virtual pill box;
connecting to a medication adherence management platform;
setting up a social group connected to a user via the platform, to help monitor user medication adherence;
inserting medication data into the platform, via the application;
inserting medication adherence data into the platform, via the application; and
tracking medication adherence of a user, by the social group.

12. The method of claim 11, further comprising synchronizing user medication data and user medication adherence data between the social group.

13. The method of claim 11, further comprising utilizing one or more sensors to add user medication adherence data to the platform.

14. The method of claim 11, further comprising tracking user movement to identify medication adherence data, and automatically entering such data into the platform.
